(19) United States
(12) Patent Application Publication
(10) Pub. No.: US 2006/0119261 A1
(43) Pub. Date: Jun. 8, 2006

(54) Organic electroluminescent device

(75) Inventor: Hyo Dae Bae, Yongsan-Cheonggu Town (KR)

Correspondence Address: FLESHNER & KIM, LLP, P.O. BOX 221200, CHANTILLY, VA, 20153, US

(73) Assignee: LG Electronics Inc.

(21) Appl. No.: 11/290,783

(22) Filed: Dec. 1, 2005

(30) Foreign Application Priority Data
Dec. 6, 2004 (KR) 2004-101865

(51) Int. Cl. H05B 33/00; H01J 1/62

(52) U.S. Cl. 313/506

(57) ABSTRACT

The organic electroluminescent device comprises a plurality of anode electrodes formed on a substrate, each anode electrode being extended in one direction; an insulating layer formed on the anode electrodes and having openings, each opening being formed on each anode electrode; a plurality of walls crossing the anode electrodes, organic electroluminescent layers formed on the openings of the insulating layer; and a plurality of cathode electrodes overlapping the organic electroluminescent layers, each cathode electrode being parallel with the walls. In the present device, the insulating layer is formed on the edges of each anode electrode and the insulating layer is not formed on the other area, and so it is possible to prevent the organic EL layer from being damaged by the concentrated voltage, and the emitting area which is not covered by the insulating layer is increased to enhance an aperture ratio of the device.

### BACKGROUND OF THE INVENTION

1. Field of the Invention

The present invention relates to an organic electroluminescent device, and particularly, to an organic electroluminescent device having a structure which can enhance its aperture ratio by maximizing an emitting area.

2. Description of the Related Art

Organic electroluminescence is the phenomenon that excitons are formed in an (low molecular or high molecular) organic material thin film by re-combining holes injected through an anode with electrons injected through a cathode, and a light of specific wavelength is generated by energy from the formed excitons. The structure and manufacturing method of the organic electroluminescent device using the above phenomenon are as follows.

FIG. 1 is a plane view of an organic electroluminescent device, and FIG. 2 is a sectional view taken along the line A-A in FIG. 1. These figures schematically illustrate the basic structure of an organic electroluminescent device.

The structure of an organic electroluminescent device is consisted of indium-tin-oxide layers 2 formed on a glass substrate 1, organic electroluminescence layers 3 (hereinafter, referred as “organic EL layer”) formed on the anode electrodes 2 with organic material, and metal layers 4 formed on the organic EL layers 3.

For reference, the organic EL layer 3 has the structure that a hole transport layer, a light emitting layer, and an electron transport layer are stacked in order, and each metal layer 4 (including the organic EL layer 3) is spaced from the adjacent metal layers with a certain distance. Here, each ITO layer 2 (hereinafter, referred as “anode electrode”) arranged on the substrate 1 acts as an anode electrode, and each metal layer 4 (hereinafter, referred as “cathode electrode”) acts as a cathode anode.

Each wall 5 is formed on a space between two adjacent cathode electrodes 4 to divide the organic EL layers 3 and the cathode electrodes 4 into a number of sections, and each wall 5 is isolated from the anode electrodes 2 through an insulating layer 4a. On the other hand, in the processes for forming the organic EL layer and the cathode electrode, the organic EL layer and the metal layer are formed on each wall 5, but this metal layer does not act as the cathode electrode.

The organic electroluminescent device having the above structure is produced through the following processes.

First, the anode electrodes 2 are formed on the glass substrate 1, the insulating layer 4a is formed on the entire area of each anode electrode 2 except certain area (emitting area) on which the organic EL layer and the cathode electrode are formed. Then, walls 5 are formed transversely on the insulating layers 2, and the organic EL layer 3 and the cathode electrode 4 are formed on the entire structure including the walls 5 in order.

FIG. 3 is a partial view showing the insulating layer and the walls, and FIG. 4 is a sectional view taken along the line B-B in FIG. 3. The above figures show the device before the organic EL layer and the cathode electrode are formed yet. In FIG. 3, also, the insulating layer is not formed yet, and the oblique lined area a is where the insulating layer is not formed (that is, emitting area).

The insulating layer 4a formed on the entire structure including the anode electrodes 2 is not formed on predetermined area a of the anode electrodes 2, and each area of the anode electrodes 2 on which the insulating layer is not formed is the light emitting area from which a light is emitted by interaction of the organic EL layers and the cathode electrodes to be formed later.

As shown in FIG. 3 and FIG. 4, the insulating layer 4a is formed on an area of each anode electrode 2 except the predetermined area a, that is, an area adjacent to the walls 5 and outer edge area, and so the emitting area a is limited, whereby the aperture ratio (a ratio of the surface area of the emitting area a to the surface area of the active area) becomes lower. In order to enhance the aperture ratio of the device, it is preferable to minimize the area on which the insulating layer is formed.

### SUMMARY OF THE INVENTION

An object of the present invention is to provide an organic electroluminescent device which can enhance its aperture ratio by minimizing the surface area of the insulating layer formed on the anode electrodes.

When a driving voltage is applied to the device, the voltage is concentrated to the edge of each anode electrode, and so the organic EL layer formed on the anode electrode is damaged by the concentrated voltage. However, the insulating layer formed on the edge of the anode electrode blocks the concentrated voltage from being transmitted to the organic EL layer, and so any damage to the organic EL layer by the insulating layer can be prevented.

Thus, the present inventor discovered that if the insulating layer is not formed on the area of each anode electrode onto which the voltage is not concentrated, the organic EL layer is not damaged, and the emitting area is remarkably enlarged, to complete the present invention.

Therefore, the organic electroluminescent device according to the present invention comprises a plurality of anode electrodes formed on a substrate, each anode electrode being extended in one direction; an insulating layer formed on the anode electrodes and having openings, each opening being formed on each anode electrode; a plurality of walls crossing the anode electrodes and dividing each opening of the insulating layer; organic electroluminescent layers formed in the openings of the insulating layer; and a plurality of cathode electrodes overlapping the organic electroluminescent layers, each cathode electrode being formed parallel with the walls. Here, each opening of the insulating layer is formed in the longitudinal direction of the anode electrode.

In the present invention, since the insulating layer is formed on only both edges of each anode electrode and the substrate between the adjacent anode electrodes, it is possible to prevent the organic EL layer from being damaged by the concentrated voltage, and the emitting area which is not covered by the insulating layer is enlarged to enhance an aperture ratio of the device.

### BRIEF DESCRIPTION OF THE DRAWINGS

The present invention will be more clearly understood from the detailed description in conjunction with the following drawings.

FIG. 1 is a plane view showing schematically the basic structure of organic electroluminescent device;

FIG. 2 is a sectional view taken along the line A-A in FIG. 1;

FIG. 3 is a view showing partially emitting areas of anode electrodes;

FIG. 4 is a sectional view taken along the line B-B in FIG. 2;

FIG. 5 is a partial plane view of the organic electroluminescent device according to the present invention, corresponding to FIG. 3;

FIG. 6 is a sectional view taken along the line C-C in FIG. 5; and

FIG. 7 is a sectional view taken along the line D-D in FIG. 5.

### DETAILED DESCRIPTON OF THE INVENTION

The structure of the organic electroluminescent device according to a preferred embodiment of the present invention and the method for manufacturing the same will be described in detail with reference to those accompanying drawings below.

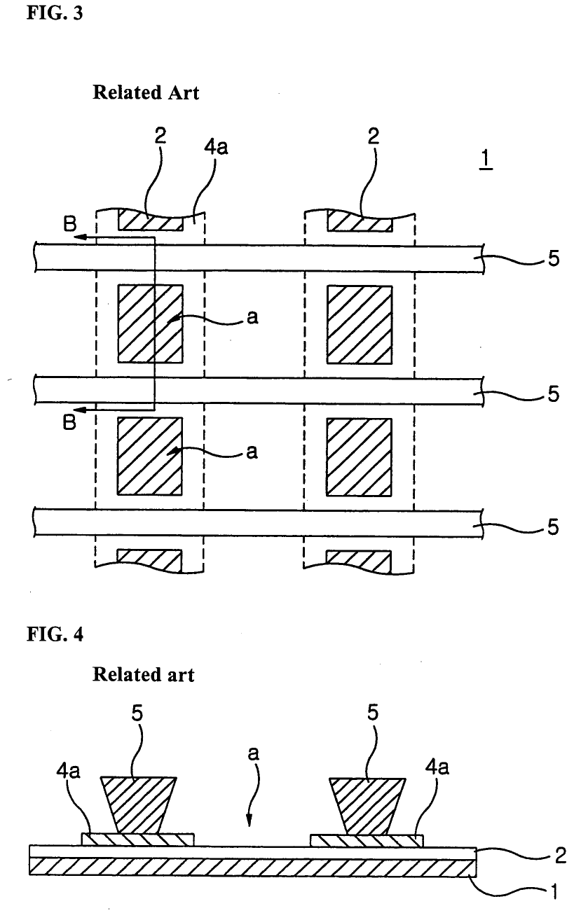

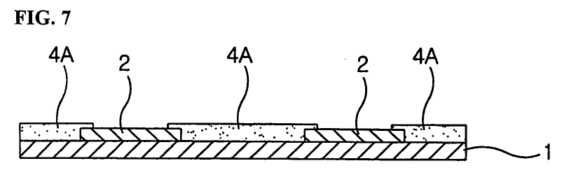

FIG. 5 is a partial plane view of the organic electroluminescent device according to the present invention, corresponding to FIG. 3. Also, FIG. 6 is a sectional view taken along the line C-C in FIG. 5, and FIG. 7 is a sectional view taken along the line D-D in FIG. 5.

For the convenience's sake, the above figures show that insulating layers 4A and the walls 5 are formed on the anode electrodes 2. In FIG. 5, also, the insulating layers 4A disposed below the walls 5 are indicated by dotted lines.

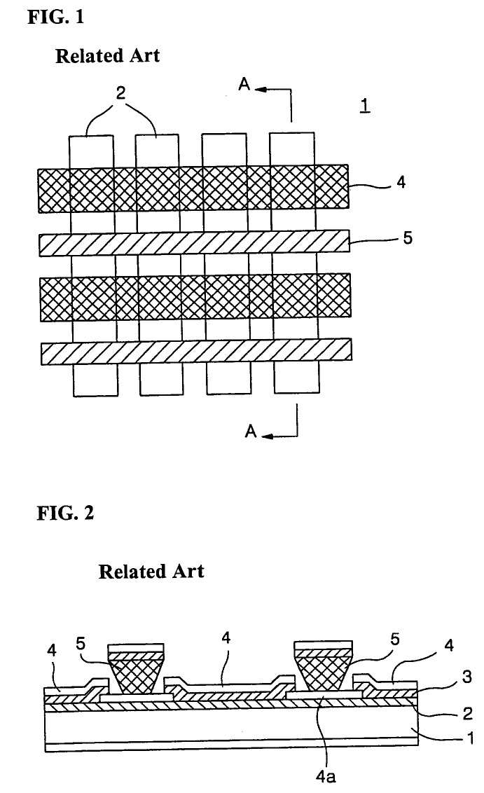

The entire structure and manufacturing method of the organic electroluminescent device according to the present invention shown in FIGS. 5 to 7 are the same as those in FIG. 1 to FIG. 4, and so the detailed description thereon is omitted. FIGS. 5 to 7 use the same reference numerals as FIGS. 1 to 4 to indicate same or similar components.

The major feature of the organic electroluminescent device according to the present invention is that the insulating layer 4A is formed on both edges portions of each anode electrode 2 and the substrate 1 between the adjacent anode electrodes 2. Also, the insulating layer 4A is formed on outsides the outermost anode electrodes.

Accordingly, as shown in FIG. 5 and FIG. 6, the insulating layer 4A has a plurality of openings in which the insulating layer is not formed, as indicated by the oblique lines. Each opening is formed on the anode electrode 2.

After the insulating layer 4A is formed, a plurality of walls 5 are formed on the anode electrodes 2 in the state that the wall crosses the anode electrodes. Also, the walls 5 divide each opening into a plurality of separate openings A, these separate openings A function as the emitting areas when the device is operating.

On the other hand, the openings are formed in the longitudinal direction of the anode electrode 2, and the insulating layer 4A is formed from material with the insulation property, for example, polyimide.

Here, one end portion of each anode electrode 2 is electrically connected to a corresponding data line (not shown) and the other end portion is covered with the insulating layer 4A.

In the structure as described above, since each anode electrode 2 has the insulating layer 4A formed on both edge sections thereof, the driving voltage is applied to the anode electrodes 2 after the organic EL layer and the cathode electrodes (not shown) are formed on the anode electrodes, and the applied driving voltage is concentrated to the edge sections of each anode electrode 2, but the organic EL layer formed on the anode electrode is not damaged thanks to the insulating layer 4A.

Assuming that the length and width of each anode electrode 2 shown in FIG. 5 are same as those of each anode electrode shown in FIG. 3, and the width of the insulating layer 4A formed on both edges of each anode electrode shown in FIG. 5 is same as that of the insulating layer 4a formed on both edges of each anode electrode shown in FIG. 3, the insulating layer 4A is not formed on the entire area of each anode electrode 2 except both edges, and so the emitting areas A (illustrated by oblique lines) on each anode electrode 2 shown in FIG. 5 are remarkably larger than the emitting area a on each anode electrode 2 shown in FIG. 3.

Consequently, the entire aperture ratio of the device (ratio of the surface area of the emitting area A to the surface area of the active area) is significantly enhanced.

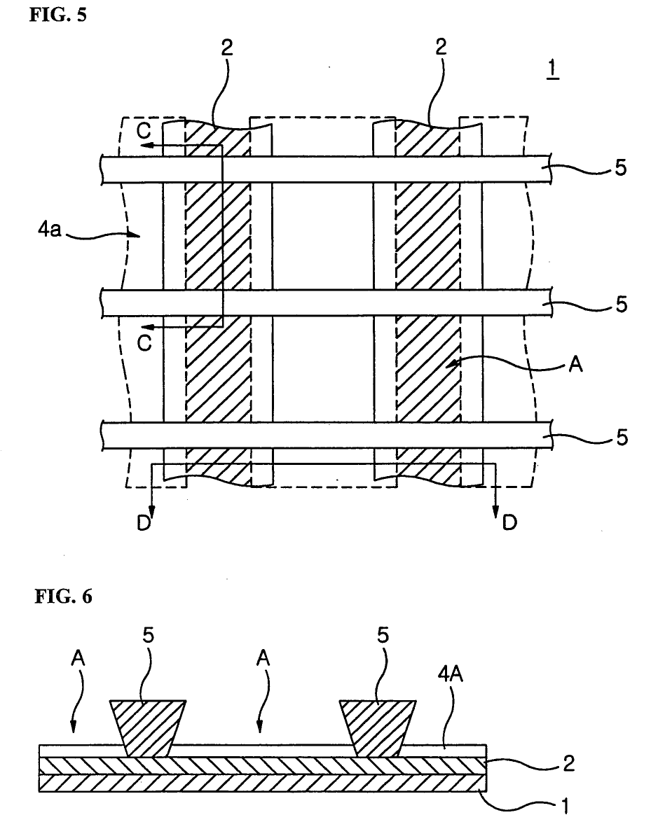

In comparison with the conventional organic electroluminescent device shown in FIG. 3 and FIG. 4, the organic electroluminescent device according to the present invention is advantageous in that damage to the organic EL layer by the voltage concentrated to the edges of each anode electrode can be prevented, and the emitting area on which the insulating layer is not formed is increased to enhance the aperture ratio.

The preferred embodiments of the present invention have been described for illustrative purposes, and those skilled in the art will appreciate that various modifications, additions, and substitutions are possible, without departing from the scope and spirit of the present invention as disclosed in the accompanying claims.

What is claimed is:

1. An organic electroluminescent device, comprising;
a plurality of anode electrodes formed on a substrate; and
an insulating layer formed on the anode electrodes and having openings, each opening being formed on each anode electrode;

2. The organic electroluminescent device according to claim 1, wherein the openings are formed in the longitudinal direction of the anode electrode.

3. The organic electroluminescent device according to claim 1, wherein the insulating layer is formed from polyimide with the insulation property.

4. The organic electroluminescent device according to claim 1, wherein the insulating layer is formed on both edge portions of each anode electrode.

5. The organic electroluminescent device according to claim 1, wherein the insulating layer is formed on the substrate between the adjacent anode electrodes.

6. The organic electroluminescent device according to claim 1, wherein the insulating layer is formed on outsides the outermost anode electrodes.

7. The organic electroluminescent device according to claim 1, further comprising a plurality of walls formed on the anode electrodes and crossing the anode electrodes.

8. The organic electroluminescent device according to claim 7, wherein the walls divide each opening formed on each anode electrode into a plurality of separate openings.

9. The organic electroluminescent device according to claim 1, wherein each anode electrode has two end portions, one end portion being connected to a data line and the other end portion being covered with the insulating layer.

10. An organic electroluminescent device, comprising;
a plurality of anode electrodes formed on a substrate;
an insulating layer formed on the structure including the anode electrodes and having openings, each opening being formed on each anode electrode;
a plurality of walls crossing the anode electrodes, the walls dividing each opening into a plurality of separate openings;
organic electroluminescent layers formed on the openings of the insulating layer; and
a plurality of cathode electrodes overlapping the organic electroluminescent layers, each cathode electrode being parallel with the walls.

11. The organic electroluminescent device according to claim 10, wherein the openings of the insulating layer are formed in the longitudinal direction of the anode electrode.

12. The organic electroluminescent device according to claim 10, wherein the insulating layer is formed from polyimide with the insulation property.

13. The organic electroluminescent device according to claim 10, wherein the insulating layer is formed on both edge portions of each anode electrode.

14. The organic electroluminescent device according to claim 10, wherein the insulating layer is formed on the substrate between the adjacent anode electrodes.

15. The organic electroluminescent device according to claim 10, wherein the insulating layer is formed on outsides the outermost anode electrodes.

16. The organic electroluminescent device according to claim 10, wherein each anode electrode has two end portions, one end portion being connected to a data line and the other end portion being covered with the insulating layer.
